(19) United States
(12) Patent Application Publication
(10) Pub. No.: US 2015/0352737 A1
(43) Pub. Date: Dec. 10, 2015

(54) DOUBLE EDGE SAFETY RAZOR WITH RAZOR BLADE ALIGNMENT

(71) Applicant: Stanley Lee Hickam, Kingsport, TN (US)

(72) Inventor: Stanley Lee Hickam, Kingsport, TN (US)

(21) Appl. No.: 14/297,489

(22) Filed: Jun. 5, 2014

(51) Int. Cl. B26B 21/52; B26B 21/18

(52) U.S. Cl. CPC B26B 21/521; B26B 21/18

(57) ABSTRACT

A double edge razor assembly with a razor blade alignment is provided. The double edge razor includes a head with a cap and a base. A post and at least one pin may protrude for the inner surface of the cap. The post and the at least one pin may snuggly fit within a channel through the razor. The post may fit through an aperture in the base, and the pin may fit within a pin hole in the base. The pin may align the razor in between the cap and the base, and prevent the razor from spinning out of alignment. The post may then attach to a handle to complete the double edge razor assembly.

### BACKGROUND OF THE INVENTION

The present invention relates to a double edge safety razor and, more particularly, to a double edge safety razor with a built in alignment for the razor portion.

A double edge razor includes a handle and a head. The head may include a cap and a base, sandwiching a razor in between. Double edge razors became popular within the United States in the early 1900s. However, the Double-edge safety razors are still being designed and produced in a number of countries in one, two and three piece designs.

Current three piece double safety razor head designs do not ensure symmetrical razor blade alignment. One side of the razors head may have a greater blade exposure than the other side. This is due to the blade having too much freedom to move while being assembled for use. Asymmetrical blade alignment can cause skin irritation and nicks. When the safety razor provides unreliable shaving results the user may be at risk and has to endure uncomfortable shaves.

As can be seen, there is a need for an improved double edge razor that prevents the misalignment of the blade.

### SUMMARY OF THE INVENTION

In one aspect of the present invention, a double edge safety razor comprises: a head comprising: a base comprising an aperture through the base and at least one base mating portion; and a cap comprising an outer surface and an inner surface, wherein the cap comprises at least one cap mating portion configured to mate with the at least one base mating portion, wherein the cap is configured to be releasably attachable to a handle by a post, wherein the post fits through the aperture of the base.

In another aspect of the present invention, a method of constructing a double edge safety razor comprises: providing a cap comprising a threaded peg and at least one pin; placing the threaded peg and the at least one pin through a double edged razor; providing a base comprising at least one pin hole and an aperture; placing the threaded peg through the aperture and aligning the at least one pin to fit within the at least one pin hole; and screwing the threaded peg into a threaded handle.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded view of an embodiment the present invention;

FIG. 3 is a front view of an embodiment the present invention;

FIG. 4 is a side view of an embodiment the present invention;

FIG. 5 is a top view of an embodiment the present invention;

FIG. 6 is an enlarged section view taken along line 6-6 in FIG. 5;

FIG. 7 is an enlarged section view taken along line 7-7 in FIG. 5;

FIG. 8 is a detailed view of the base of FIG. 1;

FIG. 9 is an enlarged section view taken along line 9-9 in FIG. 8;

FIG. 10 is a bottom view of the base of FIG. 1;

FIG. 11 is an enlarged section view of the base taken along line 11-11 in FIG. 8;

FIG. 12 is an enlarged partial section view of the base taken along line 12-12 in FIG. 9;

FIG. 13 is a bottom view of the cap of FIG. 1;

FIG. 14 is a side view of the cap of FIG. 1;

FIG. 15 is a front view of the cap of FIG. 1;

FIG. 16 is a partial section view of the handle of FIG. 1;

FIG. 17 is a perspective view of an alternate embodiment of the present invention;

FIG. 18 is a top view of the base of FIG. 17;

FIG. 19 is an enlarged section view taken along line 19-19 in FIG. 18; and

FIG. 20 is an enlarged section view taken along line 20-20 in FIG. 18.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a double edge safety razor head that enables easy symmetrical razor blade alignment. The razor head of the present invention includes the cap that may include two small pins that protrude outward. The pins may include a diameter as the narrowest space present in the hollow midline space of a double edge blade. When the blade is fitted over these pins the blade is very snug and has symmetrical spacing along both sides of the razor. The present invention may eliminate the ability for the blade to shift during assembly. Further, in certain embodiments, non sharpened edges extend slightly beyond the head making it possible to hold both the cap and blade for additional stability and safety while the razor is being assembled for use.

In certain embodiments, the cap of the present invention may slightly curve and has the small protruding pins that may ensure exact alignment of the blade. The portion of base that articulates with the cap may include the faceted edges of the large center bar running the length of the midline of the base plate. The center bar may include two tiny recesses or holes that fit the post or prongs found on the cap. The pairing of the cap with its two pins ensures a snug mount for the double edge blade. The base accepts the cap (and blade) precisely with the pins entering the previously described holes in the pin holes resulting in a razor head fitting and functioning as a single unit. The razors handle may then screw on to the threaded center post of the cap.

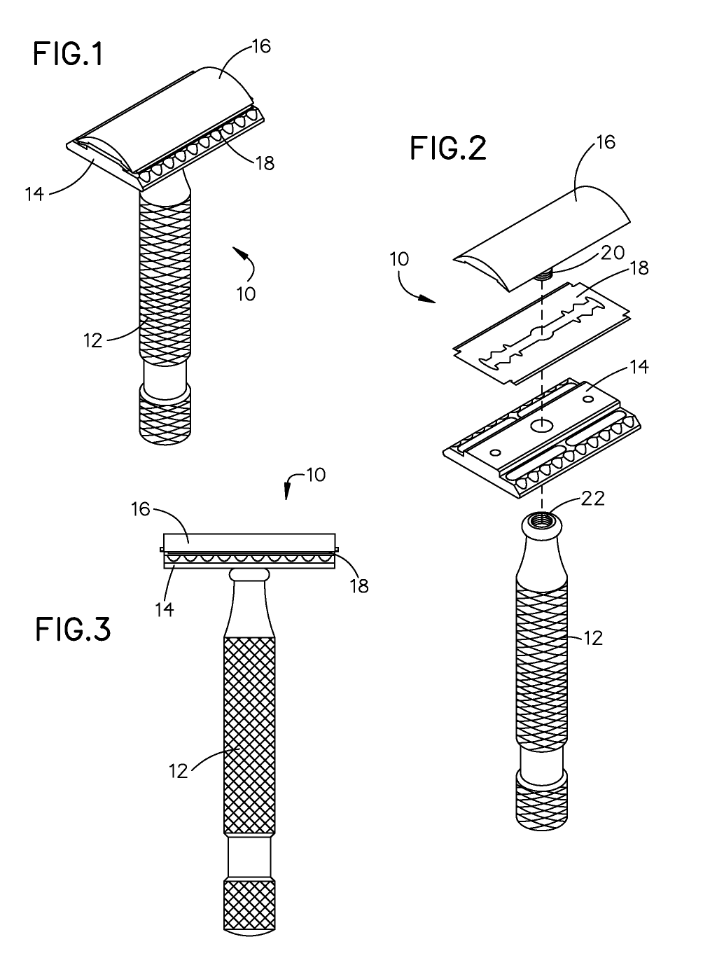

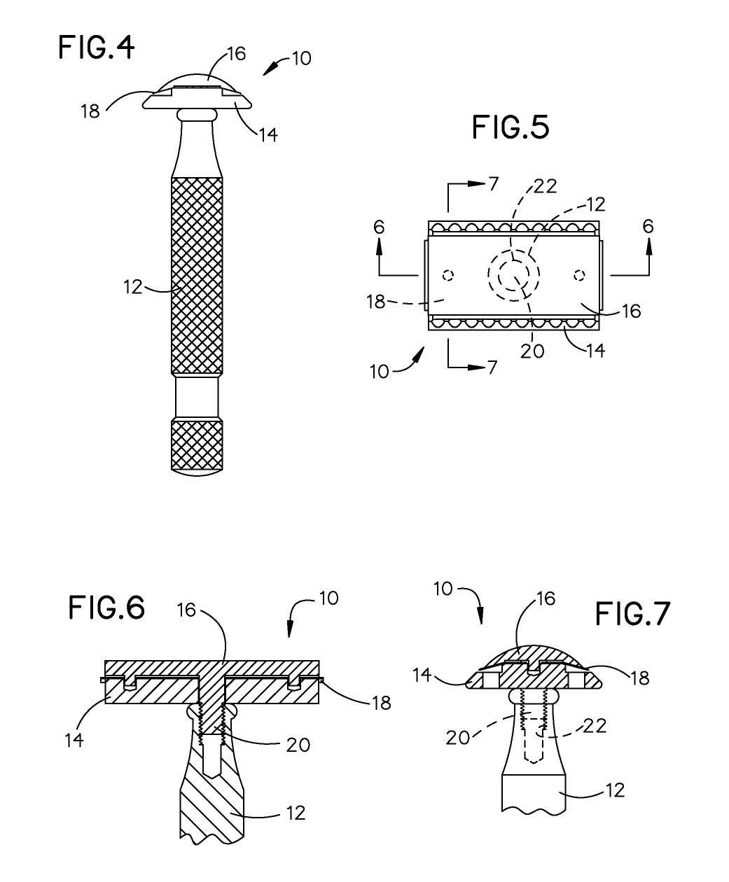

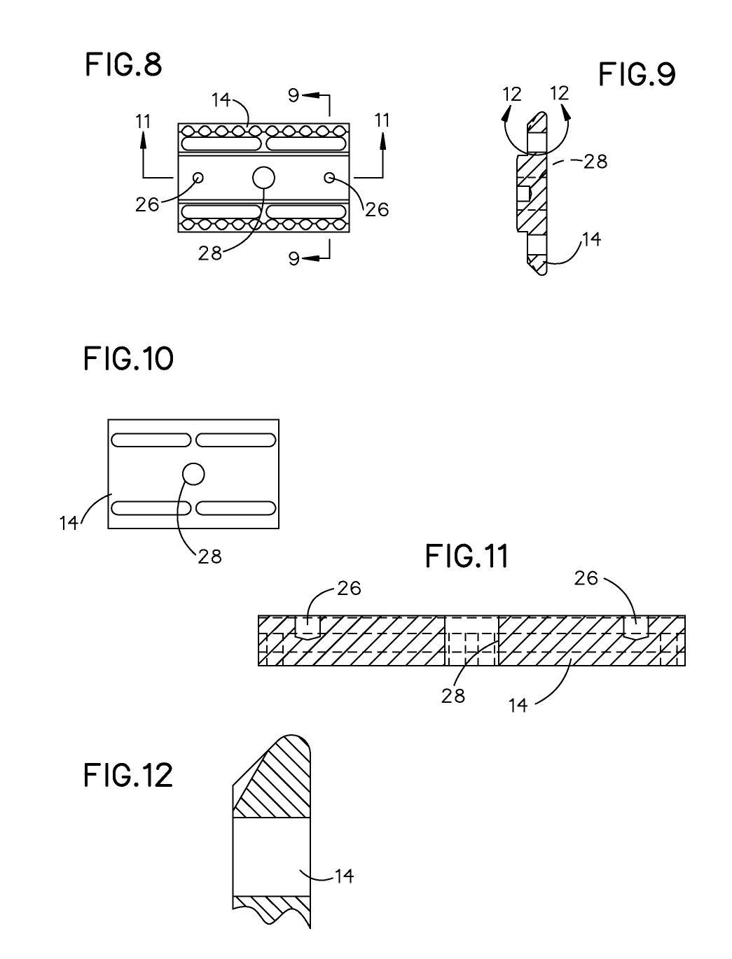

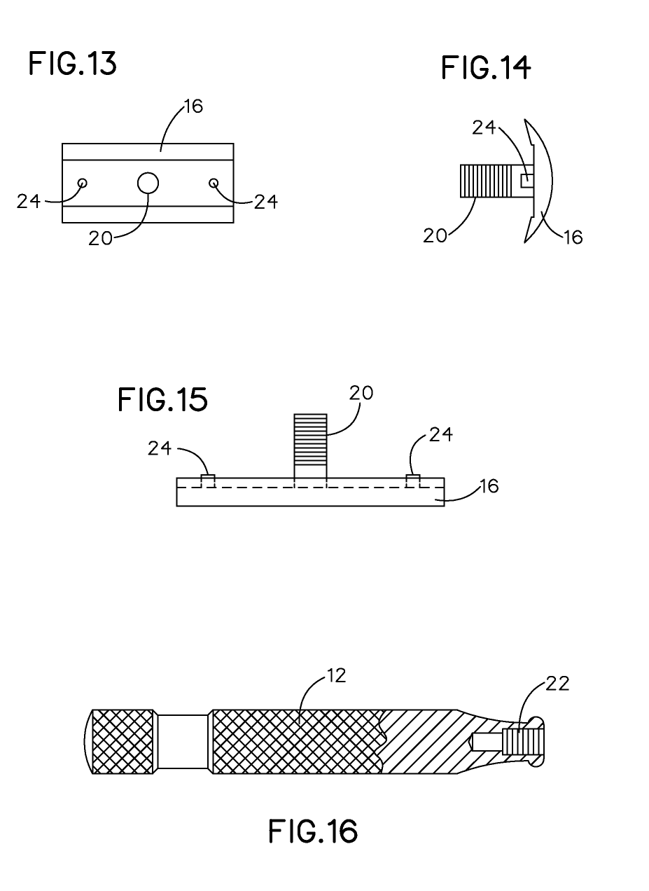

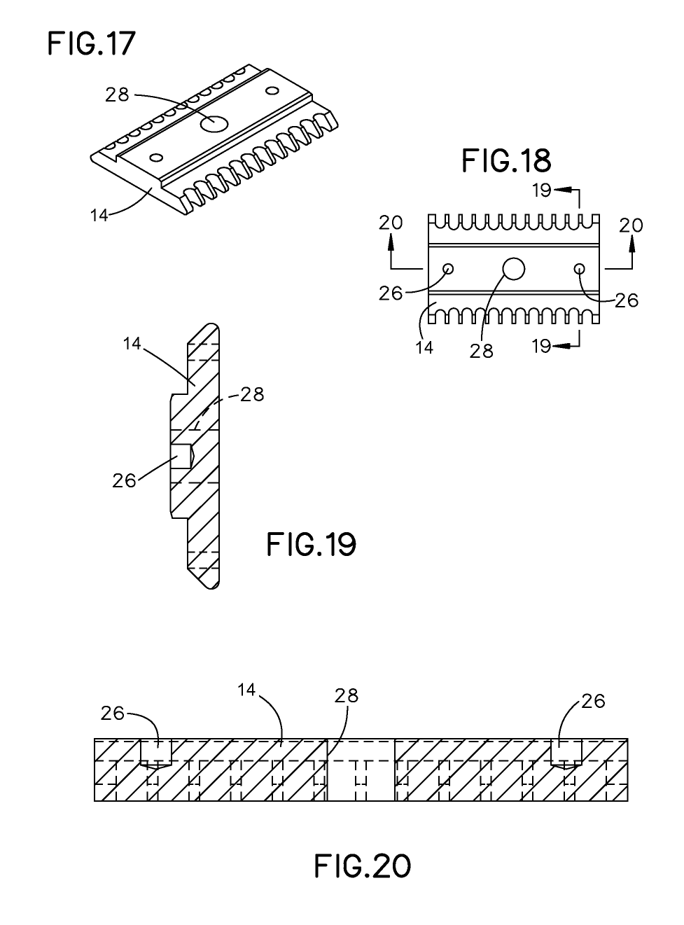

Referring to FIGS. 1 through 20, the present invention includes a double edge razor assembly 10. The double edge razor assembly 10 includes a head. The head includes a base 14, a cap 16 and a razor blade 18 sandwiched in between. The base 14 may include an aperture 28 running through the base 14, and at least one mating portion. The cap may include an outer surface and an inner surface. The cap 16 may include at least one cap mating portion configured to mate with the at least one base mating portion. The cap 16 is configured to be releasably attachable to a handle 12 by a post 20. The post 20 may be attached to the cap 16 and the handle 20 and may fit through the aperture 28 of the base 14.

In certain embodiments, the post 20 may be integrally attached to and extend from the inner surface of the cap 16. In such embodiments, the post 20 may have a threaded end. The handle 12 of the present invention may include a threaded receiver 22 formed to mate with and releasably attach to the threaded end of the post 20. The post 20 may fit through a channel within the razor blade 18, through the aperture 28 in the base 14 and screw into the threaded receiver 22 to construct the double edge razor assembly 10.

In certain embodiments, the mating portions may include a pin hole 26 and a pin 24 that fits within the pin hole 26. For example, the at least one base mating portion may include at least one pin hole 26, and the at least one cap mating portion may include at least one pin 24. The pin 24 may fit through the channel of the razor blade 18 and fit within the pin hole 26, properly aligning the razor blade 18 and preventing the razor blade 18 from rotating out of alignment. The diameter of the pin 24 may be the same or slightly smaller than the width of the channel so that pin 24 snuggly fits within the channel.

The at least one pin 24 of the present invention may include two pins 24 protruding from the inner surface of the cap 16. Further, the at least one pin hole 26 may include two pin holes 26 formed in the base 14. The two pins 24 may align with and fit within the two pin holes 26. In certain embodiments, the two pins 24 may be on either side of the post 20 and the two pin holes 26 may thereby be on either side of the aperture 28.

The present invention may further include additional characteristics. The head may be made of stainless steel or other appropriate materials. As illustrated in the drawings, the outer surface of the cap 16 may include a convex curve to aid in the comfort of shaving. The inner surface of the cap 16 may include a groove to accept the blade 18. Further, the edges along the length of the base 14 may be faceted. In certain embodiments, the double edge razor 18 may include a length greater than the head, i.e. greater than the cap 16 and the base 14. This will allow users to easily grasp and adjust the razor 18 properly.

A method of constructing the above double edge razor assembly 10 may include the following. The threaded peg 20 of the cap 16 and the at least one pin 24 may be placed through the channel of the double edge razor 18. The threaded peg 20 may then be placed through the aperture 28 of the base 14. The at least one pin 24 may be placed within the at least one pin hole 26 of the base 14. Thereby, the double edge razor 18 is sandwiched and properly aligned in between the base 14 and the cap 16. The threaded peg 10 may then screw into the threaded receiver 22 of the handle 12 to complete the double edge razor assembly 10.

It should be understood, of course, that the foregoing relates to exemplary embodiments of the invention and that modifications may be made without departing from the spirit and scope of the invention as set forth in the following claims.

What is claimed is:

1. A double edge safety razor comprising:
a head comprising:
a base comprising an aperture through the base and at least one base mating portion; and
a cap comprising an outer surface and an inner surface, wherein the cap comprises at least one cap mating portion configured to mate with the at least one base mating portion,
wherein the cap is configured to be releasably attachable to a handle by a post, wherein the post fits through the aperture of the base.

2. The double edge safety razor of claim 1, wherein the post is attached to and extends from the inner surface of the cap.

3. The double edge safety razor of claim 2, wherein the post is threaded.

4. The double edge safety razor of claim 3, further comprising the handle, wherein the handle comprises a threaded receiver formed to mate and secure to the threaded post.

5. The double edge safety razor of claim 1, wherein the at least one base mating portion is at least one pin hole formed in the base, and the at least one cap mating portion is at least one pin formed to fit within the pin hole.

6. The double edge safety razor of claim 5, further comprising a double edge razor sandwiched in between the base and the cap, wherein the double edge razor comprises a channel having a width slightly larger than the diameter of the at least one pin and the post.

7. The double edge safety razor of claim 6, wherein the double edge razor comprises a length larger than the length of the head.

8. The double edge safety razor of claim 5, wherein the at least one pin hole is two pin holes on either side of the aperture, and the at least one pin is two pins on either side of the post.

9. The double edge safety razor of claim 1, wherein edges along the length of the base are faceted.

10. The double edge safety razor of claim 1, wherein the outer surface of the cap comprises a convex curve.

11. A method of constructing a double edge safety razor comprising:
providing a cap comprising a threaded peg and at least one pin;
placing the threaded peg and the at least one pin through a double edged razor;
providing a base comprising at least one pin hole and an aperture;
placing the threaded peg through the aperture and aligning the at least one pin to fit within the at least one pin hole; and
screwing the threaded peg into a threaded handle.

12. The method of claim 11, wherein the at least one pin hole is two pin holes on either side of the aperture, and the at least one pin is two pins on either side of the post.
